(19) United States
(12) Patent Application Publication
(10) Pub. No.: US 2002/0008613 A1
(43) Pub. Date: Jan. 24, 2002

(54) Electrical connector for vehicle wiring

(76) Inventors: John F. Nathan, White Lake Township, MI (US); Thomas Vern, Grosse Pointe Park, MI (US); Michele R. Palomba, Romeo, MI (US); Scott Hamlin, Fraser, MI (US); Bert Eakins, Groveland Township, MI (US); Philip M. Kerr, Novi, MI (US); Russ Uithoven, Dearborn, MI (US); Thomas J. Gronski, Grand Blanc, MI (US); Allan Lurry, Dearborn Heights, MI (US)

Correspondence Address: TIMOTHY G. NEWMAN, Brooks & Kushman P.C., 1000 Town Center, 22nd Floor, Southfield, MI, 48075-1351, US

(21) Appl. No.: 09/780,243

(22) Filed: Feb. 9, 2001

Related U.S. Application Data
(60) Provisional application No. 60/181,764, filed on Feb. 11, 2000.

(51) Int. Cl. B60Q 1/00

(52) U.S. Cl. 340/425.5; 439/34

(57) ABSTRACT

A motor vehicle seat electrical connection system. The system comprises a first connector, a second connector, and a circuit. The circuit is normally in a first condition. When the first and second connectors are properly latched, the circuit is changed to a second condition.

### TECHNICAL FIELD

The present invention relates to motor vehicle seats, and more particularly to an electrical connector capable of indicating that the matable connector portions of a motor vehicle seat properly latch when coupled together.

### BACKGROUND ART

Generally, electrical components within a vehicle, such as an electric motor or heater in a seat, are coupled to the vehicle's power and control system via an applicable wiring harnesses. To promote serviceability of the various electrical components, these devices are attached to the wire harness using matable portions of an electrical connector. Such electrical connectors typically include mating pins and sockets to provide for the electrical coupling, and a housing formed with a latching mechanism that engages upon mating of the separate connector portions. In many situations, the latching mechanism is arranged to produce an audible sound, such as snapping sound, upon engagement of the latch.

However, a problem sometimes encountered with such electrical connectors is that during vehicle assembly, the connector portions are not always fully latched when mated together, thereby providing the potential that the connector will unmate and fail during use of the vehicle. In addition, because vehicle assembly lines are capable of producing high levels of ambient noise, the audible sound produced by latching mechanisms of the connectors cannot always be heard. Thus, verification of proper latching is typically augmented visual inspection, which is both time consuming and not always reliable.

Therefore, a need exists for an electrical connector capable of easy verification that the matable portions are properly latched when coupled together.

### DISCLOSURE OF INVENTION

In accordance with one aspect of the present invention, the above noted problem is overcome by utilizing a connector position assurance device (CPA) in conjunction with the matable portions of the electrical connector. Such CPA devices are generally known. In this embodiment, the housing of each portion of the electrical connector can include a slot or guide rail arrangement having a stop element arranged such that when the connector portions are properly mated and latched, the CPA device can be fully inserted and snapped into position within the guide rails, thereby ensuring that the connector portions are properly latched. In addition, once the CPA device is snapped into position, the CPA device operates to supplement the connector's normal latching mechanism to prevent subsequent unintentional disengagement of the connector portions.

In accordance with another aspect of the present invention, an electrical connector is provided having a built-in electrical feedback (EFB) capability such that when the connector portions are properly latched, the connector itself will be capable of automatically generating an output signal indicative of the latched condition. In one embodiment, two pins within the connector are normally shorted, but are placed into an open condition as the connector portions become fully latched. In a second embodiment, the connector is arranged so that two pins within the connector are normally in an open state, but are automatically shorted as the connector portions become fully latched. Still further, in a third embodiment, all of the various wiring connectors can be integrated into a single connection module associated with a particular vehicle component, such as an integrated seat adjuster module for a vehicle seat. Both types of EFB connectors can be advantageously used with such a module, thereby allowing the module to include a connector self-diagnostic circuit and/or program. In other words, the module will automatically receive a signal output from a connector as it is coupled and fully latched, thereby providing immediate indication that the connector is properly latched.

The above objects and other objects, features, and advantages of the present invention are readily apparent from the following detailed description of the Best Mode for Carrying Out the Invention when taken in connection with the accompanying drawings.

### BRIEF DESCRIPTION OF DRAWINGS

FIG. 1 is an exploded perspective view of an electrical connector having electrical feedback in accordance with a first embodiment of the present invention;

FIG. 2 is an elevated perspective view of the electrical connector of FIG. 1 showing the connector portions in a fully latched position;

FIG. 3 is an elevated perspective view of an electrical connector having electrical feedback in accordance with a second embodiment of the present invention;

FIG. 4 is an elevated perspective view of the electrical connector of FIG. 3 showing the connector portions in a fully latched position;

FIG. 5 is a perspective view of an exemplary embodiment of a centralized connector/control module; and

FIG. 6 is a block circuit diagram of a system having a plurality of EFB connectors in accordance with the present invention.

### BEST MODE FOR CARRYING OUT THE INVENTION

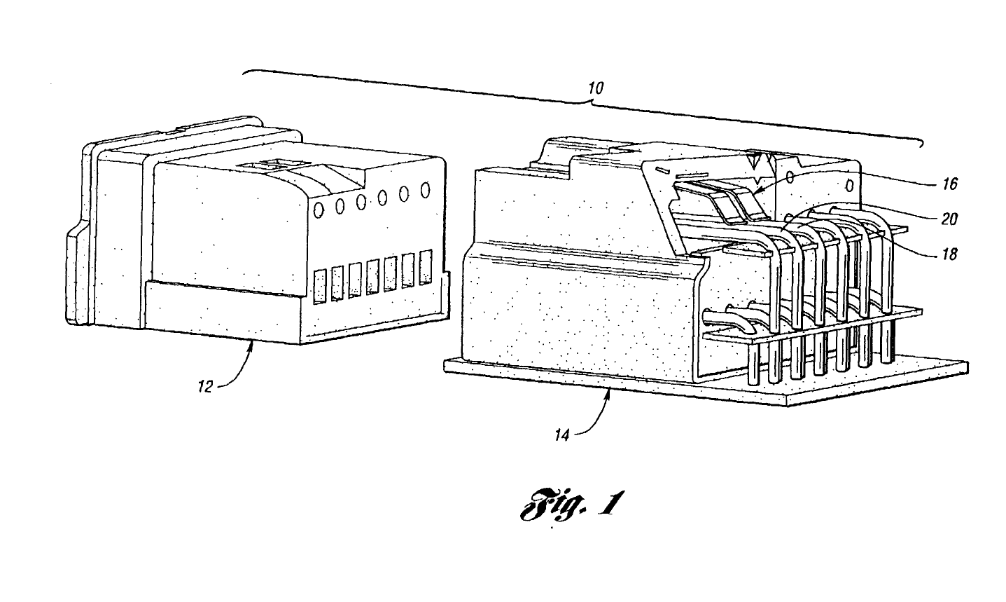

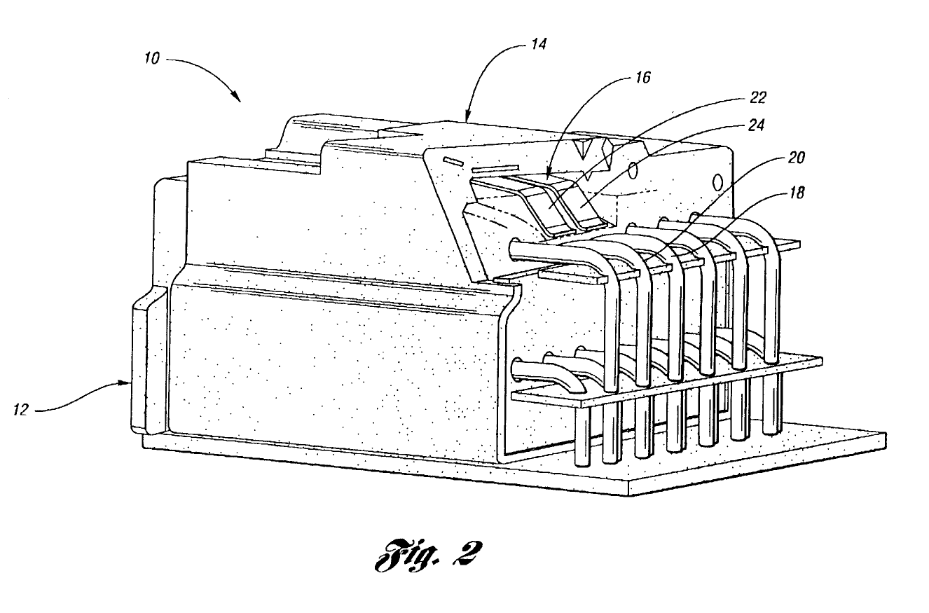

Referring to FIGS. 1 and 2, an EFB connector 10 is shown in accordance with a first embodiment of the present invention. More specifically, connector 10 includes a male connector portion 12 which is mated with a female connector portion 14. In accordance with the present invention, female connector portion 14 includes a spring biased conductor element 16 arranged to make contact between two output pins 18 and 20 when connector portions 12 and 14 are not in a latched condition. In the embodiment shown, connector device 16 includes individual metal fingers 22 and 24 which are positioned to be biased into physical contact with pins 18 and 20 when the connector is in an unlatched state. As best seen in FIG. 2, as male portion 12 is fully inserted and latched into female portion 14, the housing of portion 12 engages fingers 22 and 24 and pushes them out of contact with pins 18 and 20. Thus, with this embodiment, pins 18 and 20 are in a shorted condition which allows current to pass through the two pins when the connector is not fully latched. However, as the connector portions obtain a fully latched position, the two pins are then placed into an open state. The switch over from a shorted state to an open state can then be detected by a testing or a monitoring arrangement.

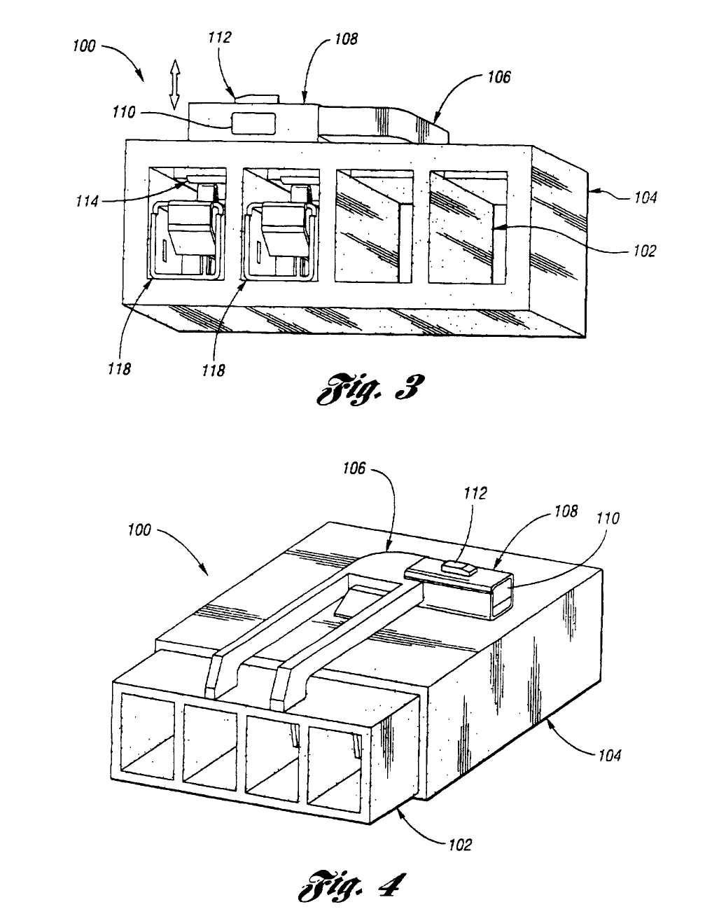

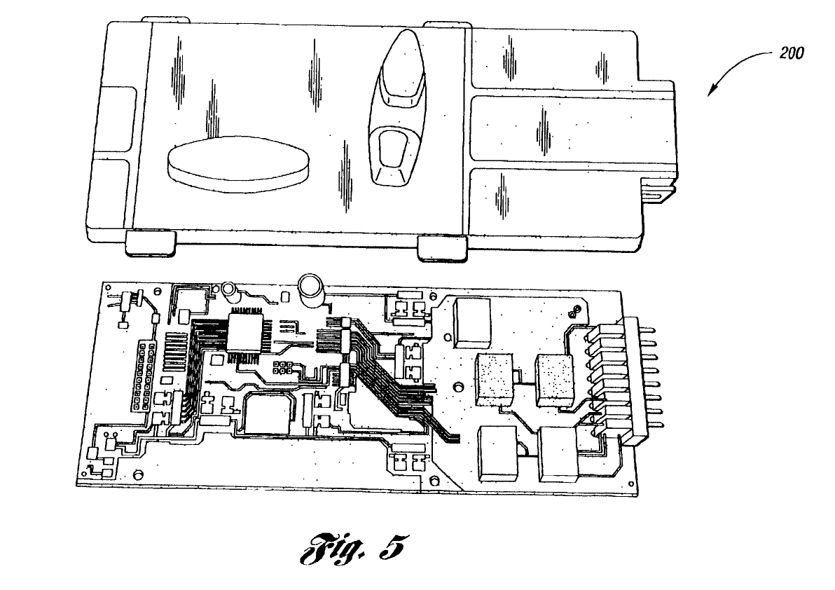

Referring now to FIGS. 3 and 4, an EFB connector 100 is shown in accordance with a second embodiment of the present invention. More specifically, connector 100 includes a male connector portion 102 which mates within a female connector portion 104. Each housing of connector portion 102 and 104 include cooperating latch mechanism elements 106 and 108 respectively. As best seen in FIG. 4, when male connector portion 102 is fully inserted into female portion 104, latch portion 106 pivots or flexes so that an extension member 110 inserts within latch catch element 108. When properly latched, a protrusion 112 on extension member 110 snaps into a corresponding opening into latch catch element 108.

As best seen in FIG. 3, as extension 110 is inserted into latch element 108, the latch element is forced downward such that a conductive element 114 incorporated into latch catch mechanism 108 is brought into physical contact with a pair of pins 116 and 118. Thus, with this embodiment, pins 116 and 118 are normally in an open state when the connector is not fully latched, but upon proper latching of the connector portions, the pins are placed into a shorted state. In this manner, a testing or monitoring arrangement can detect the switchover from an open condition to a shorted condition to detect proper latching of the connector.

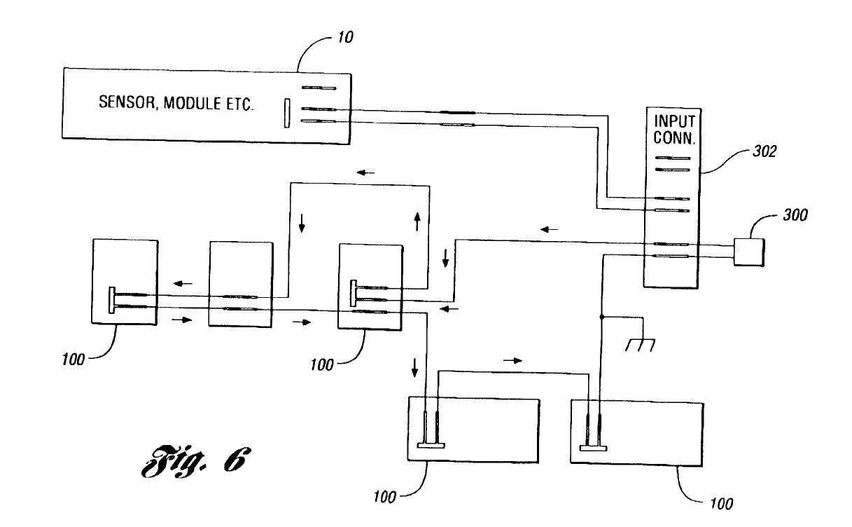

Referring now to FIG. 5, the EFB connectors of the present invention are advantageously used in conjunction with an integrated connector/control module 200, such as an integrated seat adjuster module illustrated in the figure. The integrated module allows connection and control of various electrical components within the vehicle, such as a seat motor and seat heater, to be centralized in a single location. Such an arrangement improves serviceability while reducing other cost factors associated with individual wiring connections. In addition, because the EFB connectors of the present invention produce an output switchover signal upon proper latching of the connector, the integrated module can include a self-diagnostic circuit and/or programming as part of its design. With this arrangement, an output signal can be immediately generated at the time of assembly which indicates or verifies that each of the appropriate connectors have been properly latched.

Referring now to FIG. 6, a wiring block diagram is shown illustrating use of both EFB connectors 10 and 100 in conjunction with a continuity testing arrangement. More specifically, as shown, a testing device 300 can be connected into an input connector 302 that is attached via the wiring harness to one or more EFB connectors 10 (only one is shown), and multiple, daisy chained connectors 100. As illustrated in the figure, when connector 10 is properly latched, the two pins are placed into an open condition. When each of the connectors 100 are properly latched, current is able to flow continuously from one pin of the input connector 302 to a second pin on the input connector 302. In this manner, tester 300 is able to determine the proper electrical state of the various connectors.

In accordance with the present invention, EFB connectors 10 are particularly applicable with electronic modules and sensor type devices having a built-in processing capability. Such arrangements are easily adapted to provide a built-in detection mechanism capable of sensing the switchover to the shorted state upon latching of the connector portions. Such devices can then be made to set a fault code or flag if the connector is not fully latched.

EFB connectors 100 are particularly applicable to devices that do not have a built-in processing ability, such as electrical switches and motors. The ability to switchover to a shorted condition as the connector portions are fully latched allows a simply continuity tester to verify latching of the connection.

While the embodiments of the invention shown and described above constitute preferred embodiments of the invention, they are not intended to illustrate all possible forms thereof. For instance, the present invention has application beyond the field of vehicle seats. It should also be understood that the words used are words of description rather than limitation, and various changes may be made without departing from the spirit and scope of the invention disclosed.

We claim:

1. A motor vehicle seat electrical connection system, comprising:
a first connector;
a second connector; and
means for generating an electric feedback signal indicative of proper latching between the first and second connectors.

2. The system of claim 1 wherein the first connector is in electrical communication with an electrical component.

3. The system of claim 1 wherein the first connector is in electrical communication with a motor.

4. The system of claim 1 wherein the first connector is in electrical communication with a seat heater.

5. The system of claim 1 wherein the second connector is in electrical communication with a wire harness.

6. The system of claim 1 wherein the means for generating comprises a normally shorted electrical circuit.

7. The system of claim 1 wherein the means for generating comprises a normally open electrical circuit.

8. A motor vehicle seat electrical connection system, comprising:
a first connector;
a second connector; and
a circuit that is normally in a first condition, the circuit being changed to a second condition when the first and second connectors are properly latched.

9. The system of claim 8 wherein the circuit generates a feedback signal upon being changed to the second condition.

10. The system of claim 8 wherein the first condition of the circuit is open.

11. The system of claim 8 wherein the first connector is in electrical communication with an electrical component.

12. The system of claim 8 wherein the first connector is in electrical communication with a motor.

13. The system of claim 8 wherein the first connector is in electrical communication with a seat heater.

14. The system of claim 8 wherein the second connector is in electrical communication with a wire harness.
